(19) United States
(12) Patent Application Publication
(10) Pub. No.: US 2015/0092940 A1
(43) Pub. Date: Apr. 2, 2015

(54) Method for Complete Atomic Blocks for Elliptic Curves in Jacobian Coordinates over Prime Fields Countermeasure for Simple-Side Channel Attacks and C-Safe-Fault Attacks for Right-to-Left Algorithms

(71) Applicant: Universidad de Santiago de Chile, Santiago (CL)

(72) Inventors: Rodrigo ABARZUA, Santiago (CL); Nicolas Theriault, Concepcion (CL)

(73) Assignee: Universidad de Santiago de Chile, Santiago (CL)

(21) Appl. No.: 14/044,544

(22) Filed: Oct. 2, 2013

(51) Int. Cl. H04L 9/00; G06F 7/72

(52) U.S. Cl. CPC H04L 9/002; G06F 7/725; H04L 2209/08
USPC 380/28

(57) ABSTRACT

The present invention describes a method which improves the safety aspects of the previously published atomic blocks for the right-to-left case. This method builds new sets of atomic blocks designed to protect against both simple side-channel attacks and C-safe fault attacks for scalar multiplication for elliptic curves over prime fields. In particular, they comprise eliminating the use of dummy operations in the atomic blocks used in the scalar multiplication ([d]P), which are based on elliptic curves defined on fields of prime characteristic.

### BACKGROUND OF THE INVENTION

1. Technical Fields

The invention relates to the safety technology field. Particularly, the present invention relates to atomic blocks for cryptosystems based on elliptic curves over finite fields of prime characteristic known as ECC-systems.

2. Background

Elliptic Curves Cryptography (ECC) is a public-key cryptosystem proposed by Neal Koblitz [Koblitz87] and Victor Miller [Miller86] in 1985 which provides significant advantages in several situations, including implementations on specialized microprocessors. For example, some industry standards require 1024-bits for the size of integers in the RSA system, whereas the equivalent requirement for ECC is to work with finite fields of 160-bits. Given the restrictions on embedded microprocessors (used in mobile devices), the ECC system is an interesting option to obtain the required security.

Side-channel attacks exploit physical leakages of a cryptographic process on a device (using timing [Kocher96], power consumption [Kocher99] and electromagnetic radiation [Quisquater01, Gandolfi01]). These attacks present a realistic threat to cryptographic applications, and have been demonstrated to be very effective against smart cards without proper countermeasures. There are two general strategies with regard to these attacks: Simple Side-channel Analysis (SSCA) [Kocher96] which analyses the measurements of a single scalar multiplication, observing the differences in the behavior of the scalar multiplication depending on the value of the secret key; and Different Side-channel Analysis (DSCA) [Kocher99], which uses statistical techniques to retrieve information about the secret key based on the measurements from several scalar multiplications. This work will be focused on SSCA.

Several proposals have been made to protect scalar multiplication against these attacks. For example, the double-and-add-always algorithm of Coron [Coron99] ensures that the sequence of operations to compute a scalar multiplication is independent of the value of the secret scalar by inserting a dummy point addition between consecutive doublings (when the bit of the scalar is 0). A second countermeasure is to use unified formulae which use similar sets of field operations for both the general group additions and doublings. Such formulae exist for Edwards curves [Edwards07], inverted Edwards curves [Bernstein07], curves in the Huff model [Joye10], Hessian curves [Smart01], Jacobi curves [Liardet01, Billet02], Weierstrass elliptic curves [Brier02] (more details can be found in the database of special elliptic curves [Bernstein-Lange]). Another possible countermeasure is the Montgomery ladder [Montgomery97] designed for a special type of curve in large characteristic. As for the double-and-add-always algorithm, it makes sure that every bit of the scalar corresponds to both a doubling and an addition, but with the supplementary condition that both operations have an impact on the final output of the scalar multiplication. This was later generalized to all elliptic curves [López99, Brier02, Goundar11], and right-to-left scalar multiplication Double-add of Joye's [Joye03] and zeroless signed-digit algorithm [Goundar11]. A fifth approach consists in using “regular” representations of the scalar [Moeller01, Theriault05, Joye07], with the same fixed sequence of group operations for all scalars. Finally, Side-Channel Atomicity (first proposed by Chevallier-Mames et al. [Chevallier04]) splits point operations into small homogeneous blocks of basic field operations. If it is carefully implemented, it becomes impossible to distinguish between atomic blocks coming from doublings or additions. Atomic blocks are potentially the most efficient SSCA countermeasure.

A number of refinements have been provided to the atomic blocks structure since the paper published by Chevallier-Mames et al. An early assumption in atomic blocks design was that field multiplication and squaring are indistinguishable to side-channel analysis [Chevallier04, Chen09, Elmegaaed09, Giraud10], but it was later showed that the two operations can be distinguished even when they are equally treated by the processor [Amiel09, Hanley11].

As a result, an efficient and secure atomic block should consider distinct squarings and multiplications in its structure. Applying such atomic blocks to existing formulae can be rather inefficient since several dummy operations have to be introduced. Both Longa and Miri [Longa08] and Bernstein and Lange [Bernstein07] presented a flexible methodology to modify group operations formulae to fit it better in atomic blocks that could distinguish between the two field operations, by turning some multiplications into squarings [Longa08].

However, one problem has usually not been addressed in previous works on atomic blocks. If a group or field operation is introduced to provide side-channel uniformity but these operations do not affect the final output, then these “dummy” operations open the way to C-safe fault attacks [Yen00]. These attacks consist in introducing a fault in the scalar multiplication at a point corresponding to a suspected dummy operation, e.g. guessing what the next (non-dummy) group operation should be. If the final output is still valid, the guess was correct, whereas if the fault produces an error in the final output, then the guess was incorrect. Through this process, an attacker can obtain the secret scalar through observation of a few observations of the scalar multiplication.

As a result, it is recommended to avoid using dummy operations in the formulae [Avanzi05]. These attacks can be considered more closely related to DSCA than SSCA (although they are mathematically simpler than other DSCA), but they require far fewer observations than most other DSCA.

The Jacobian coordinates formulae of Abarziúa and Thériault [Abarzua12] for left-to-right scalar multiplication can be considered the current best in atomic blocks formulae countermeasure for Simple-side channel attacks and C-safe-fault.

The object matter of this invention is securing the atomic blocks formulae against Simple side-channel attacks and C-safe fault attacks for: General addition, modified Jacobian coordinates and Mixture Jacobian and Chudnovsky-Jacobian, using for the right-to-left algorithm improving the results [Elmegaaed09] and [Giraud10].

### Mathematical Background

For a detailed description of elliptic curves, see [Avanzi05, Washington08]. An elliptic curve E defined over a large prime field is GF(p) given by an equation of the form y²=x³+ax+b, with 4a³+27b² 00. The group used for cryptography consists of the (affine) point (x,y) on the curve and the point at infinity “0” (the neutral element), with the “chord-and-tangent” addition. The group operation for (p, q)+(r, s) is given by

(x,y)=(λ²−p−r,λ(p−x)−q)

where λ=(q−s)/(p−r) if p≠r (addition formula) and λ=(3p²+a)/(2q) if (p, q)=(r, s) (doubling formula) and (p, q)+(p, −q)=0
Jacobian coordinates are a projective representation of the points consisting of equivalence classes of the form:

(X:Y:Z)=(λ²X,λ³Y,λZ):λεGF(p) (1)

A Jacobian point (X:Y:Z) with Z≠0 corresponds to the affine point (x, y)=(X/Z², Y/Z³).

### Rescaling Methodology

The “rescaling” methodology presented by Longa and Miri [Longa08] and Bernstein and Lange [Bernstein07] takes advantage of the projective form of the point coordinates.

The principal idea consists in taking a field multiplication αβ, and replacing it with a number of field squarings, additions and negation

2αβ=(α+β)²−α²−β² (2)

If λ=2 in the class description (1), it can be easily seen how factors of 2 can be incorporated into all of the coordinates (in the invention, from the output of the computation). It can then be used to replace the computation of some multiplications by equation (2) adjusting the remaining computations accordingly.

The technique presented in [Longa08, Bernstein07] can be summarized in two steps:
1. Replacing one (or more) of the field multiplications by applying the algebraic substitution given in Equation (2).
2. Modifying the point formula by inserting multiples of 2 in the point representation, using the equivalence (X:Y:Z)˜(2²X:2³Y:2Z).

### State of the Art for Atomic Blocks

In this section, a more detailed description of previous works on block-atomicity for elliptic curves for use in left-to-right and right-to-left scalar multiplication is presented.

Atomic blocks formulae are a very promising method to secure scalar multiplication against SSCA. The idea was first introduced by Chevallier-Manes et al. [Chevallier04] and consists in partitioning point operations into small homogeneous atomic blocks, which cannot be distinguished from each other through SSCA, thus making it impossible for the attacker to know which block is part of a group doubling or addition. Any field operation of an atomic block that is not used by the formula would be filled with dummy operations so that no missing operation would be identified by a SSCA. By staying “as close as possible” to the optimized formula, an atomic block formula can then provide the desired security at a much lower price than other SSCA countermeasures.

Chen et al. in [Chen09], presented an experimental attack on a smart card using an implementation of the atomic blocks proposed by Chevallier-Mames et al. [Chevallier04]. This experimental attacks utilizes the different number atomic blocks for group doublings and additions—for total operation times of 3.16 ms and 3.61 ms respectively—and a delay of 1.12 ms for breaks between group operations. This experimental attack could be applied because the implementation did not avoid irregular breaks between atomic blocks within the same group operation and distinct group operations. Chen et al. proposed to balance the point doubling with respect to a group addition. A preferred option is to require a better management of the delays between atomic blocks, thus allowing for formulae with different numbers of blocks.

The original atomic block of Chevallier-Mames et al. had a structure of (M, A, N, A) Multiplication-Addition-Negation-Addition operations over the prime field. This atomic block made one important assumption: that multiplication and squaring are indistinguishable from a side-channel perspective. This was disproved by Amiel et al. [Amiel09] and Hanley et al. [Hanley11]. Since the Hamming weight for the results of a field multiplication and squaring have different distributions, and the Hamming weight affects the side-channel traces, it is possible to use this difference to distinguish between blocks containing a general multiplication and those containing a squaring operation, re-opening the way to SSCA. As a consequence, atomic blocks should consider distinct squaring and multiplication in their structure.

This distinction can also have some efficiency benefits when considering that specialized squarings are less expensive than multiplication (at a ratio close to 0.8 in practice [Giraud10]). In order to adapt the existing formulae to various atomic block structures, the flexible methodology introduced by Longa and Miri [Longa08], and Bernstein and Lange [Bernstein07] can prove very useful. It permits the modification of point operations formulae to balance the number of squarings and multiplication, thus facilitating the introduction of squarings into atomic blocks.

Elmegaaed, in [Elmegaaed09], presented atomic blocks with structure (M, A, N, A) a mixture of Chudnovsky-Jacobian and Jacobian coordinates wherein if the I/M ratio is 60 or more, are used during scalar multiplication for right-to-left algorithm. Unfortunately these blocks make use of dummy operations and squarings and multiplications were considered to be side-channel equivalent.

Longa and Miri presented a new atomic block structure based on the sequence Squaring-Negation Addition-Multiplication-Negation Addition-Addition of field operations or (S, N, A, M, N, A, A). They applied their atomic block structure to doubling, tripling and mixed addition for elliptic curves in Jacobian coordinates over prime fields. It should be noted that these atomic blocks formulae make use of dummy operations at one point or another at the very least to fill up some of the additions and/or negations.

Giraud et al. in [Giraud10], presented new atomic blocks for Jacobian Addition and Modified Jacobian Doubling. In particular Giraud presented atomic blocks with structure (S, A, M, A, M, A, M, A, A, S, M, A, N, A, M, N, A, N, A, M, N, A) to obtain efficient scalar multiplication for the right-to-left algorithm introduced by Joye in [Joye08]. It should be noted that atomic blocks presented in [Giraud10] make use of dummy operations and consider that a multiplication and square side-channel equivalent.

As stated above, previously published atomic blocks formulae for elliptic curves defined over prime fields are open to C-safe fault attacks [Yen00]. Although most balanced formulae do fill out all the multiplications and squarings with non-dummy operations, no such consideration is applied to field additions and negations.

Experimental data on various smart cards [Giraud10] provide an addition-to-multiplication ratio close to 0.2 and a negation-to-multiplication ratio of 0.1. Even though the timing for these operations is much less than for multiplications and squarings (the squaring-to-multiplication ratio is usually close to 0.8), it would still be reasonable to mount a C-safe fault attack on dummy field additions and negations.

The only way to really avoid C-safe fault attacks is to ensure that every field operation of every atomic block is used in the computation of the final result. Note that it would not be sufficient to repeat the same operation more than once in the formula (using each result at least once), since the repeated operations would leave an essentially identical side-channel signature, thus re-opening the way to SSCA. Due to the aforementioned, all field operations of every atomic block must be filled but always with different operands.

Abarziúa and Thériault in [Abarzua12] presented the Jacobian coordinates formulae of left-to-right scalar multiplication which can be considered the current best in atomic blocks formulae that protect against simple side-channel attacks and C-safe faults attacks for the case left-to-right algorithm using the following operations: doubling, mixed addition, tripling, and quintupling. In the right-to-left case, they also provide formulae for Doubling in Modified Jacobian Coordinates and General Jacobian Addition.

### BRIEF SUMMARY OF THE INVENTION

The demand for wireless technology (cell phones, smart card) has significantly increased in recent years. Most of these devices rely on embedded microprocessors to secure the data being transmitted. Providing efficient cryptographic algorithms is a fundamental issue for the development of secure wireless devices.

One of the tools being investigated as a possible method to improve the security of these devices consists of public key cryptosystems, particularly cryptographic systems based on elliptic curves.

The present invention describes a method which improves the safety aspects of the previously published atomic blocks for the right-to-left case. This method builds new sets of atomic blocks designed to protect against both simple side-channel attacks and C-safe fault attacks for scalar multiplication for elliptic curves over prime fields. These atomic blocks are structured with the sequence of field operations (S, N, A, A, M, A), Squaring, Negation, Addition, Addition, Multiplication, Addition. These atomic blocks are applied to various operations in Jacobian coordinates: General addition, Doubling Jacobian modified, Mixture Jacobian and Chudnovsky-Jacobian for use in right-to-left scalar multiplication.

As in previous atomic blocks formulae, the group operations of this invention provide protection against simple side channel attacks by dividing the group operations into smaller sequences of field operations. One of the main differences with other formulae resides in their security against C-safe fault attacks. Unlike previous works, the formulae of this method are designed to completely fill the atomic blocks with field operations that affect the final output (i.e. to avoid “dummy” operations) and are all distinct (none of the operations are repeated). They also have the added bonus of being slightly more “compact” than most previous atomic blocks, having fewer additions/negations for each multiplication/squaring, potentially providing a performance gain.

In this invention, atomic blocks formulae are presented for doubling in Modified Jacobian Coordinates, General Jacobian Coordinates Addition and Mixted Jacobian and Chudnovsky-Jacobian Coordinates Addition, to be used in right-to-left algorithms, improving on the results of [Elmegaaed09] and [Giraud10].

### Method to Design Blocks the Atomic:

From the existing formulae (doubling in Modified Jacobian Coordinates, General Jacobian Addition and Mixted Jacobian and Chudnovsky-Jacobian Coordinates Addition) determining that the most favorable form for the atomic blocks would be with 1S+1M (since most formulae were close to be balanced), with the squaring before the multiplication (due to the importance of squarings early in the formulae).
Balancing the number of squarings and multiplications in the formula using the technique of Longa and Miri [Longa08] and Bernstein and Lange [Bernstein07].
Drawing a directed graph of the dependencies in the squarings and multiplications (ignoring the field additions and negations), and trying to create ordered pairs (Sᵢ,Mᵢ) (one squaring followed by one multiplication) allowing to go through the graph using each operation only once.
Starting with the ordered pairs (Sᵢ,Mᵢ), look for the minimal numbers of field additions and negations required to complete the formula, and try to determine their respective position (being particularly focused on the first and last blocks since those tend to be the least flexible of the formula). This process leads to (S, N, A, A, M, A) blocks and a first version of the atomic block formulae as well, but they are not necessarily secured against C-safe fault attacks.
Using simple algebraic identities, fill all the “spaces′” in the formulas, for example: computing 3a as 2a+a or 2(2a)−a, computing 4a as 2(2a) or 2a+a+a, careful positioning the negations (multiplications by −1), or 2b³=(b²+b)²−(b⁴+b²).

In the following subsections, the resulting atomic blocks are described, providing protection against both simple side-channel attacks and C-safe fault attacks for use in right-to-left scalar multiplication.

A compact and efficient solution is described that protects the scalar multiplication ([d]P) algorithm used in cryptosystems based on elliptic curves (ECC) from simple side-channel attacks [Kocher96, Kocher99] and C-Safe fault attacks [Yen00]. The described method has a more compact structure in comparison to the existing solutions and specifically corresponds to the atomic structure: Squaring, Negation, Addition, Addition, Multiplication, Addition (S, N, A, A, M, A). If the cryptographic algorithm used to calculate the scalar multiplication reads the scalar in a right-to-left direction, the formulae present atomic blocks for General Addition, Modified Jacobian doubling and Mixture Jacobian and Chudnovsky Jacobian. Particularly, this invention is for elliptic curves defined over a prime field. The technique presented by Longa in [Longa08] and Bernstein-Lange [Bernstein07] is applied to balance multiplications and squarings in the previously indicated formulae in addition to the use of algebraic identities to eliminate “dummy” operations, which is a vulnerability present in all atomic blocks previously presented by the scientific community [Chevaliar04, Longa08, Chen09, Elmegaaed09, Giraud10], wherein this vulnerability is used to apply C-safe fault attacks [Yen00]. Moreover, these blocks have a more compact structure than the existing atomic blocks, which results in a better computing performance.

A more detailed explanation of the invention is provided in the following detailed descriptions and appended claims taken in conjunction with the accompanying drawings.

### BRIEF DESCRIPTION OF THE DRAWINGS

FIG. 1. The flow graph describes how to use the different atomic blocks of the invention.

### DETAILED DESCRIPTION OF THE INVENTION

The following is a detailed description and explanation of the preferred embodiments of the invention and best modes for practicing the invention.

The following methodology is used for generating the new atomic blocks of this invention.

The methodology is based on atomic blocks protecting against simple side-channel attacks (SSCA) and C-Safe fault attacks, eliminating the use of dummy operations in the scalar multiplication ([d]P), for cryptosystems based on elliptic curves defined over fields of prime characteristic.

In order to eliminate the dummy operations which can be subject to C-safe fault attacks, algebraic substitutions are used to write formulae for: General Addition, Modified Jacobian doubling and Mixted Jacobian and Chudnovsky Jacobian Addition, when the scalar multiplication is implemented with right-to-left algorithms. These atomic blocks have a compact and efficient atomic structure (S, N, A, A, M, A).

First of all, in order to build atomic blocks it is necessary to balance the number of multiplications and squarings using the method presented in [Longa08] and [Bernstein07]. Besides which, the new algebraic substitutions are employed to eliminate the use of “dummy” operations. From the balanced formulae in relation to the number of squarings (S) and multiplications (M), a graph of algebraic operations is generated (one for each of the previous algorithms: General Addition, Modified Jacobian doubling and Mixed Jacobian and Chudnovsky Jacobian Addition) wherein said graph indicates the flow that must be executed for creating each one of the previous algorithms. This shows the dependencies of multiplications, squarings, additions and negations on the defining field of the elliptic curve to perform the calculation of algorithms.

As a result of the analysis of this directed graph containing dependency operations, ordered pairs (Sᵢ,Mᵢ) are created (a squaring followed by a multiplication per each atomic block). The minimum quantity of additions and negations required for each formula is enumerated, and each position thereof is determined by observing the directed graph containing the data dependency operations. A special case takes place in relation to the first and last atomic blocks considering they have less flexibility in the formulae or algorithms that will be presented in this invention.

Based on the minimum number of operations, the most efficient and compact structure possible is the structure (S, N, A, A, M, A) for all previously mentioned algorithms. This results in a more compact structure than previously published formulae, enhancing the safety aspects of all previously presented atomic blocks.

After determining the most efficient structure for these atomic blocks when using right-to-left algorithms for the scalar multiplication ([d]P), formulae and atomic blocks are written for the Modified Jacobian Doubling case ([2]P), as shown in Table 1.

### Modified Jacobian Point Doubling in Jacobian Coordinates

This representation, introduced by Cohen et al. in [Cohen98] is based on Jacobian coordinates. In this representation of a point P, the quadruple (X₁:Y₁:Z₁:a Z₁), called Modified Jacobian representation, is used to reduce the computation cost of doubling a point.

Let P=(X₁:Y₁:Z₁:aZ₁) be a point in Modified Jacobian representation, on the elliptic curve E. The most efficient doubling formula (with the output also in Jacobian coordinates) requires 4M+4S+12A+3N. In terms of multiplication (M), squaring (S), addition (A), and negation (N), there is little change from previous formulae, however additions and negations were re-organized to fill the operations in the atomic blocks.

A=3X₁²+W₁,

−C=2B(−X₁), B=2Y₁²,

X₂=A²−2C −D=2(−B²),

Z₂=(2Y₁)Z₁ R=X₂−C,

W₂=(−2D)(−W₁), Y₂=(−A)R−D,

The resulting atomic blocks can be found in Table 1, taking as input X₁→R₁, Y₁→R₂ and Z₁→R₃, and returning as output X₂→R₁, Y₂→R₂, Z₂→R₃ and

TABLE 1
Atomic block formula for Modified Jacobian Doubling

| | Block 1 | Block 2 | Block 3 | Block 4 |
|---|---|---|---|---|
| S | R [symbol] ← R₁² | R [symbol] ← R₂² | R₅ ← R₅² | R₄ ← R₁² |
| | [X₁²] | [Y₁²] | [B²] | [A²] |
| N | R₆ ← −R₁ | R₇ ← −R₄ | R₅ ← −R₅ | R₇ ← −R₁ |
| | [−X₁] | [−W₁] | [−B²] | [−A] |
| A | R₇ ← R₂+ R₂ | R₅ ← R₅ + R₅ | R₈ ← R₅ + R₅ | R₁ ← R₄ + R₆ |
| | [2Y₁] | [B] | [−D] | [X₂] |
| A | R₁ ← R₃ + R₅ | R₂ ← R₅ + R₅ | R₅ ← R₈ + R₈ | R₄ ← R₁ + R₂ |
| | [2X₁²] | [2B] | [−2D] | [R] |
| M | R [symbol] ← R₇R [symbol] | R₂ ← R₂R₆ | R₅ ← R₅R₇ | R₇ ← R₇R₄ |
| | [Z₂] | [−C] | [W₂] | [−AR] |
| A | R₁ ← R₁ + R₅ | R₆ ← R₂ + R₂ | R₁ ← R₁ + R₄ | R₂ ← R₇ + R₈ |
| | [3X₁²] | [−2C] | [A] | [Y₂] |

[symbol]

indicates data missing or illegible when filed

In table 1, it is possible to observe the operations being performed by each atomic block and their respective registers Rᵢ. In this case, 8 registers are used. In addition, in order to eliminate “dummy” operations, the general algebraic substitution 3a=2a+a is used.

### General Addition in Jacobian Coordinates

Given the points P=(X₁,Y₁,Z₁) and Q=(X₂,Y₂,Z₂) in Jacobian coordinates, both on the elliptic curve E. To obtain a practical formula for block atomicity formula for the addition P+Q=(X₃,Y₃,Z₃), two multiplications must be replaced with squarings, four of which are new, to get 9M+9S:

−A=X₁(−Z₂²),

B=X₂Z₁²,

E=B−A,

2D=Y₂[(Z₁²+Z₁)²−(Z₁²)²−Z₁²],

−2C=−Y₁[(Z₂²+Z₂)²−(Z₂²)²−Z₂²],

2F=2D−2C,

X₃=(2F)²−(2E²)(2E)+8(−AE²),

Y₃=−2F[(2F)²−(2E²)(2E)+12(−AE²)]−2C(2E²)(2E),

Z₃=E[(Z₁+Z₂)²−Z₁²−Z₂²].

The resulting atomic blocks can be found in Table 2 with inputs X₁→R₁, Y₁→R₂, Z₁→R₃, X₂→R₄, Y₂→R₅ and Z₂→R₆ and returning as output X₃→R₁, Y₃→R₂, and Z₃→R₃.

TABLE 2
Atomic block formula for General addition

| | Block 1 | Block 2 | Block 3 |
|---|---|---|---|
| S | R₇ ← R₃² | R₃ ← R₆² | R₁₃ ← R₁₁² |
| | [Z₁²] | [Z₂²] | [E²] |
| N | R₈ ← −R₇ | R₁₂ ← −R [symbol] | R₂ ← −R [symbol] |
| | [−Z₁²] | [−Z₂³] | [−3Y₁] |
| A | R [symbol] ← R₇ + R₃ | R [symbol] ← R₃ + R₆ | R₁₄ ← R₁₃ + R₁₃ |
| | [Z₁² + Z₁] | [Z₂² + Z₂] | [2E²] |
| A | R₁₀ ← R₂ + R₂ | R₂ ← R₁₀ + R₂ | R₁₅ ← R₁₁ + R₁₁ |
| | [2Y₁] | [3Y₁] | [2E] |
| M | R₁₁ ← R₄R₇ | R₁ ← R [symbol] R₁₂ | R₁₄ ← R₁₄R₁₅ |
| | [B] | [−A] | [4E [symbol] ] |
| A | R₄ ← R₃ + R₅ | R₁₁ ← R₁₁ + R₁ | R [symbol] ← R [symbol] + R₁₂ |
| | [Z₁ + Z₂] | [E] | [−Z₁² − Z₂²] |
| | Block 4 | Block 5 | Block 6 |
| S | R₃ ← R₃² | R₆ ← R₆² | R₂ ← R₇² |
| | [Z₂⁴] | [(Z₂² + Z₂)²] | [Z₁⁴] |
| N | R [symbol] ← −R [symbol] | R₁₁ ← −R₁₁ | R₂ ← −R₂ |
| | [−Z [symbol] ] | [−E] | [−Z₁⁴] |
| A | R [symbol] ← R₃ + R₁₂ | R [symbol] ← R [symbol] + R [symbol] | R [symbol] ← R [symbol] + R [symbol] |
| | [−Z₂⁴ − Z₂²] | [(Z₂ [symbol] + Z₂)² − Z₂⁴ − Z₂ [symbol] ] | [−Z₁⁴ − Z₁²] |
| A | R₂ ← R₂ + R₁₀ | R₁₂ ← R₁₀ + R₁₀ | R₈ ← R [symbol] + R₁ |
| | [−Y₁] | [−4AE²] | [−7AE²] |
| M | R₁ ← R₁R₁₃ | R₃ ← R₂R [symbol] | R₇ ← R [symbol] R₁₄ |
| | [−AE²] | [−2C] | [−8C E [symbol] )] |
| A | R₁₀ ← R₁ + R [symbol] | R [symbol] ← R₁₂ + R₁₀ | R₂ ← R [symbol] + R₁ |
| | [−2AE²] | [− [symbol] AE²] | [−8AE²] |
| | Block 7 | Block 8 | Block 9 |
| S | R [symbol] ← R [symbol] | R [symbol] ← R₄² | R₁₅ ← R [symbol] |
| | [(Z₁² + Z₁)²] | [(Z₁ + Z₂)²] | [4F²] |
| N | R [symbol] ← −R₁₄ | R [symbol] ← −R [symbol] | R [symbol] ← −R₁₃ |
| | [−4E³] | [−2F] | [Z₃] |
| A | R₁₄ ← R₈ + R [symbol] | R₁₄ ← R₂ + R [symbol] | R [symbol] ← R [symbol] + R₁₀ |
| | [(Z₁² + Z₁)² − Z₁⁴ − Z₁²] | [−12AE²] | [X₃] |
| A | R₁₀ ← R [symbol] + R [symbol] | R [symbol] ← R [symbol] + R [symbol] | R [symbol] ← R [symbol] + R [symbol] |
| | [−4E [symbol] − 8AE²] | [(Z₁ + Z₂)² − Z₁² − Z₂²] | [X₃ − 4AE²] |
| M | R [symbol] ← R₅R₁₄ | R₁₃ ← R₁₁R₄ | R₁₄ ← R [symbol] R [symbol] |
| | [2D] | [−Z₃] | [−2F(X₃ − 4AE²)] |
| A | R [symbol] ← R [symbol] + R₃ | R [symbol] ← R [symbol] + R₁₄ | R [symbol] ← R₁₄ + R₇ |
| | [2F] | [−4E [symbol] − 12AE²] | [Y [symbol] ] |

[symbol]

indicates data missing or illegible when filed

In the case of General Addition in Jacobian Coordinates (P+Q), the formulae and atomic blocks are shown in table 2, wherein 16 registers are used and the algebraic substitutions applied to eliminate the use of dummy operations are 2b³=(b²+b)²−(b⁴+b²). This last formula is correct when calculating the square of a Binomial on the right side of the equality, and it will be observed that this is the same with respect to the left side after eliminating some of the expressions having opposite signs. In addition, the expression 4AE²−X₃ is calculated as

4AE²−X₃=[(2E)²−(2E²)(2E)−12(AE²)].

Finally, an expression of the type c=2a+b is replaced with c=(a+b)+a.

Mixture Jacobian and Chudnovsky-Jacobian coordinates

Elmeggaed in [Elmegaaed09] presented a new atomic blocks for Mixted Jacobian and Chudnovsky-Jacobian coordinates.

Let P=(X₁,Y₁,Z₁) in Jacobian coordinates and Q=(X₂,Y₂,Z₂,E₂,F₂) in Chudnovsky-Jacobian coordinate, with E₂=Z₂² and F₂=Z₂³. To obtain a practical formula for block atomicity formula for the addition P+Q=(X₃, Y₃, Z₃) 8M+8S+24A+8N are required:

U₁=X₁E₂,

U₂=X₂Z₁²,

S₁=(−Y₁)F₂,

S₂=(2Y₂)(X₁³),

H=U₁−U₂,

−R=S₂−S₁,

G=[2(H²+H)²−2(H²)−2(H²)²],

−V=[(H²)²−(2U₁+H₂)²]+(2U₁)²,

G−2V=[G+2[(H₂)²−(2U₁+H²)²]]+2(2U₁)²,

X₃=[G−2v]+R²,

Y₃=−GS₁−R(X₃−V),

Z₃=[(Z₁+Z₂)²−(Z₁²+E₂)]H.

The resulting atomic blocks can be found in Table 3, taking as input X₁→R₁, Y₁→R₂, Z₁→R₂, X₂→R₄, Y₂→R₅, Z₂→R₆, E₂→R₆ and F₂→R₈ and returning as output X₃→R₁, Y₃→R₂, and Z₃→R₃.

In the case of Mixture Jacobian and Chudnovsky-Jacobian coordinates, formulae and atomic blocks are presented in Table 3, wherein 12 registers are used. In addition to some of the previously exposed algebraic identities, two new algebraic identities are also applied to eliminate the use of dummy operations:

4H³=2(H²+H)²−2(H²)−2(H²)²,

−4U₁H²=[(H²)²−(2U₁+H²)²]+(2U₁)².

G−2V=G+2[(H²)²−(2U₁+H²)²]+2(2U₁)².

TABLE 3
Atomic block formula Mixture Jacobian and Chudnovsky-Jacobian coordinates

| | Block 1 | Block 2 | Block 3 | Block 4 |
|---|---|---|---|---|
| S | R₉ ← R₃² | R₁₁ ← R₄² | R [symbol] ← R₁₀² | R₉ ← R₆² |
| | [Z₁²] | [(Z₁ + Z₂)²] | [H²] | [(H² + H)²] |
| N | R₁₀ ← −R₄ | R [symbol] ← −R₆ | R₂ ← −R₆ | R₆ ← −R [symbol] |
| | [−X₂] | [−2Y₁] | [−(Z₁² + E₂)] | [−H²] |
| A | R₄ ← R₃ + R₆ | R₆ ← R₉ + R₇ | R [symbol] ← R [symbol] + R [symbol] | R₁₁ ← R [symbol] + R₆ |
| | [Z₁ + Z₂] | [Z₁² + E₂] | [H² + H] | [−2H²] |
| A | R [symbol] ← R₂ + R₂ | R₇ ← R [symbol] + R [symbol] | R₁₂ ← R₁₁ + R₂ | R [symbol] ← R [symbol] + R [symbol] |
| | [2Y₁] | [2Y₂] | [(Z₁ + Z₂)² − (Z₁² + E [symbol] )] | [2(H² + H)²] |
| M | R₂ ← R₁R [symbol] | R [symbol] ← R₁₀R₉ | R₂ ← R [symbol] R₉ | R₉ ← R₄R₈ |
| | [U₁] | [−U₂] | [Z₁³] | [−S₁] |
| A | R₁ ← R₂ + R₂ | R₁₀ ← R₂ + R₅ | R [symbol] ← R₁ + R [symbol] | R₄ ← R₅ + R₁₁ |
| | [2U₁] | [H] | [2U₁ + H²] | [2(H² + H)² − 2H²] |
| | Block 5 | Block 6 | Block 7 | Block 8 |
| S | R [symbol] ← R [symbol] | R [symbol] ← R [symbol] ² | R₉ ← R₁² | R₁₁ ← R₂² |
| | [(H²)²] | [(2U₁ + H²)²] | [(2U₁)²] | [R²] |
| N | R [symbol] ← −R₆ | R₁₁ ← −R [symbol] | R₁₁ ← −R₁₀ | R [symbol] ← −R₇ |
| | [−(H²)²] | [−(2U₁ + H²)²] | [−H] | [Z [symbol] ] |
| A | R₈ ← R₅ + R₅ | R₇ ← R₆ + R₁₁ | R₄ ← R₇ + R₉ | R [symbol] ← R₁₁ + R₁₀ |
| | [−2(H²)²] | [(H²)² − (2U₁ + H²)²] | [−V] | [X₃] |
| A | R [symbol] ← R₄ + R [symbol] | R [symbol] ← R₇ + R₇ | R [symbol] ← R₉ + R₉ | R₆ ← R₁ + R [symbol] |
| | [G] | [2((H²)² − (2U₁ + H²)²)] | [2(2U₁)²] | [X₃ − V] |
| M | R₄ ← R₇R₂ | R₈ ← R₅R₉ | R₇ ← R₁₂R₁₁ | R [symbol] ← R₂R₆ |
| | [S₂] | [−GS₁] | [−Z₃] | [(−R)(X₃ − V)] |
| A | R₂ ← R₄ + R [symbol] | R₆ ← R₅ + R₅ | R₁₀ ← R₆ + R₅ | R₂ ← R [symbol] + R₉ |
| | [−R] | [G] + | [G − 2V] | [Y₃] |
| | | [2((H²)² − (2U₁ + H²)²)] | | |

[symbol]

indicates data missing or illegible when filed

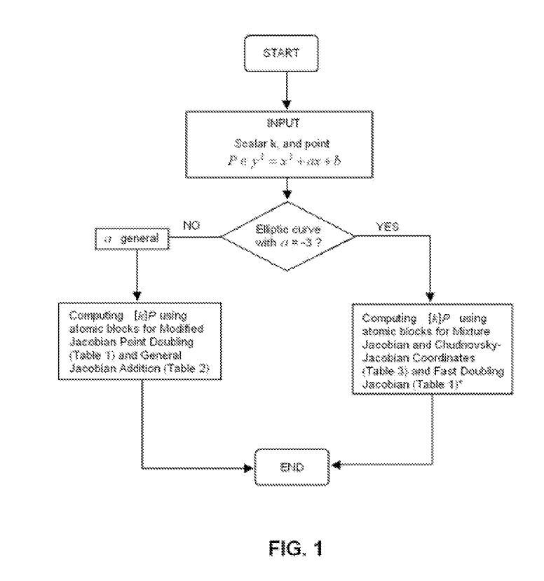

FIG. 1 shows how to use the different atomic blocks of the present invention.

The system and the atomic blocks that must be used for a cryptosystem implemented by means of right-to-left algorithms.

### Comparison Among Different Atomic Blocks

The following table compares the cost of the atomic blocks presented in [Giraud10] and [Elmegaaed09] to those we obtained.

It should be noticed that as well as giving protection against C-safe fault attacks.

Assuming experimental average ratios to multiplications of S/M≈0.8, A/M≈0.2 and N/M≈0.1 in [Giraud10], in the case Modified Jacobian Projective there is no performance loss. For the case of Mixted Jacobian and Chudnovsky Jacobian Addition there is a performance improvement of 4.7%. For the case of General Addition there is a performance loss of 12.5%.

| Operations | This work | Previous work |
|---|---|---|
| Modified Jacobian | 4M + 4S + 12A + 4N | 6M + 2S + 10A + 4N, |
| Doubling | | [Giraud10] |
| General Jacobian | 9M + 9S + 27A + 9N | 12M + 4S + 20A + 8N, |
| Addition | | [Giraud10] |
| Mixture Jacobian | 8M + 8S + 24A + 8N | 14M + 28A + 14N, |
| and Chudnovsky | | [Elmegaaed09] |

The formulae presented in the current invention were implemented in the Magma software for verifying its proper performance. Its mathematical performance was analyzed in comparison to the other atomic blocks countermeasures and it was obtained a more efficient solution with respect to what exists in the state of the art for the case of using right-to-left algorithms in the scalar multiplication of a cryptosystem based on elliptic curves.

Although embodiments of the invention have been shown and described, it is to be understood that various modifications, substitutions, and rearrangements of parts, components, and/or process (method) steps, as well as other uses, shapes, construction, and design of the Method for Complete Atomic Blocks for Elliptic Curves in Jacobian Coordinates over Prime Fields Countermeasure for Simple-Side Channel Attacks and C-Safe-Fault Attacks for Right-to-Left Algorithms can be made by those skilled in the art without departing from the novel spirit and scope of this invention.

### BIBLIOGRAPHIC REFERENCES

[Abarzua12] R. Abarziúa and N. Thériault, Complete Atomic Blocks for Elliptic Curves in Jacobian Coordinates over Prime Fields, LatinCrypt 2012, LNCS 7533, pp. 37-55, Springer 2012.
[Amiel09] F. Amiel, B. Feix, M. Tunstall, C. Whelan, and W. P. Marnane, Distinguishing Multiplications from Squaring Operations. Selected Areas in Cryptography—SAC 2008, LNCS 5381, pp. 346-360, Springer, 2009.
[Avanzi05] R. Avanzi, H. Cohen, C. Doche, G. Frey, T. Lange, K. Nguyen, and F. Vercauteren, “Handbook of Elliptic and Hyperelliptic Curve Cryptography” Champan \& Hall/CRC Press, 2005.
[Avanzi06] R. Avanzi, “Delaying and Merging Operations in Scalar Multiplication: Applications to Curve-Based Cryptosystems.” Selected Areas in Cryptography—SAC 2006, LNCS 4356, pp. 203-219, Springer, 2006.
[Bernstein-Lange] D. J. Bernstein and T. Lange. Explicit formulas data base. http://www.hyperelliptic.org/EFD/.
[Billet02] O. Billet and M. Joye, “The Jacobi Model of an Elliptic Curve and Side-Channel Analysis” Cryptology ePrint Archive Report 2002/125. http://eprint.iacr.org/2002/125/, 2002.
[Bernstein07] D. J. Bernstein and T. Lange, “Faster addition and doubling on elliptic curves. Advances in Cryptology”—ASIACRYPT 2007, LNCS 4833, pp. 29-50, Springer, 2007.
[Brier02] E. Brier and M. Joye, “Weierstrass Elliptic Curve and Side-Channel Attacks.” Public Key Cryptography—PKC 2002, LNCS 2274, pp. 335-345, Springer, 2002.
[Chevallier04] B. Chevallier-Manes, M. Ciet, and M. Joye, “Low-Cost Solution for Preventing Simple Side-Channel Analysis: Side-Channel Atomicity.” IEEE Trans. Computers, vol 53, no. 6, pp. 760-768, June 2004.
[Chen09] T. Chen, H. Li, K. Wu, and F. Yu “Countermeasure of ECC against Side-channel Attacks: Balanced Point Addition and Point Doubling Operation.” Procedure 2009 Asia-Pacic Conference on Information Processing.
[Cohen98] H. Cohen, T. Ono, and A. Miyaji, “Efficient Elliptic Curve Exponentiation Using Mixed Coordinates.” Advances in Cryptology ASIACRYPT-98 vol. 1514 LNCS pp. 51-65. Springer, 1998.
[Coron99] J. Coron, “Resistance Against Differential Power Analysis for Elliptic Curve Cryptosystems.” Cryptographic Hardware and Embedded Systems, CHES 1999, Lecture Notes in Comput. Sci. vol. 1717, pp. 392-302, Springer-Verlag, Berlin, 1999.
[Elmegaaed09] L. Elmegaaed-Fessel. Method and Systems for Atomicity for Elliptic Curve Cryptosystems. United States Patent Application Publication, Pub. No. US 2009/0046851 A1. Feb. 19, 2009.
[Edwards07] H. M. Edwards. “A normal form for elliptic curves.” Bull. Am. Math. Soc., New Ser., 44(3): 393-422, 2007.
[Giraud10] Ch. Giraud and V. Verneuil, “Atomicity Improvement for Elliptic Curve Scalar Multiplication” CARDIS 2010.
[Goundar11] R. Goundar, M. Joye, A. Miyaji, M. Rivain, and A. Venelli, “Scalar Multiplication on Weierstass Elliptic Curves from Co—Z Arithmetic” Journal of Cryptographic Engineering vol 1 (2) pp. 161-176 Springer 2011.
[Gondolfi01] K. Gandolfi, C. Mourtel, and F. Olivier. “Electronic analysis: concrete results,” Cryptographic Hardware and Embedded Systems CHES 2001, Lecture Notes in Comput. Sci., vol. 2162, Springer-Verlag, Berlin, 2001, 251261.
[Hanley11] N. Hanley, M. Tunstall, and W. P. Marmane, “Using Templates to Distinguishing Multiplications from Squaring Operations.” International Journal Information Security, series 10(4), pp. 255-266, 2011.
[Joye08] M. Joye, “Fast Point Multiplication on Elliptic Curves Without Precomputation.” Arithmetic of Finite Fields—WAIFI 2008, LNCS 5130, pp. 36-46, Springer, 2008.
[Joye10] M. Joye, M. Tibouchi, and D. Vergnaud, “Huff's Model for Elliptic Curves.” Algorithmic Number Theory—ANTS-9, LNCS 6197, pp. 234-250, Springer, 2010.
[Joye03] M. Joye and S.-M. Yen, “The Montgomery Powering Ladder.” Cryptographic Hardware and Embedded Systems—CHES 2002, LNCS 2523, pp. 291-302, Springer 2003.
[Joye07] M. Joye, “Highly Regular Right-to Left Algorithms for Scalar Multiplication”. Cryptographic Hardware and Embedded Systems—CHES 2007, LNCS 4727, pp. 135-147, Springer, 2007.
[Koblitz87] N. Koblitz. “Elliptic Curve Cryptosystems.” Mathematics of Computation vol. 48, pp. 203-209, 1987.
[Kocher96] P. Kocher, “Timing attacks on implementation of Diffie-Hellman RSA, DSS and other systems.” In: Proc Advances in Cryptology CRYPTO'96, Santa Barbara, August, 1996 LNCS 1109 (Springer-Verlag, 1996) pp. 104-113.
[Kocher99] Kocher, P. Jaffe, J. Jun, B., Differential power Analisis. Proc Advances in Cryptology—CRYPTO'99, Santa Barbara, August, 1999 LNCS 1666 (Springer-Verlag, 1999) pp 388-397.
[Liardet01] P. Y. Liardet and N. P. Smart, “Preventing SPA/DPA in ECC Systems Using the Jacobi Form.” Cryptographic Hardware and Embedded Systems—CHES 2001, LNCS 2162, pp. 401-411, Springer, 2001.
[Longa08] P. Longa and A. Miri. “Fast and Flexible Elliptic Curves Point Arithmetic over Prime Fields”. IEEE Trans. on Computers. Vol 57, No. 3, March 2008.
[Lopez99] J. L\'opez and R. Dahab, “Fast Multiplication on Elliptic Curves over $GF(2̂m)$ without Precomputation.” Cryptographic Hardware and Embedded Systems—CHES 1999, LNCS 1717, pp. 316-327, Springer, 1999.
[Miller86] V. S. Miller. “Use of elliptic curves in cryptography.” In Advances in Cryptology-Crypto 1985. LNCS 218, pp. 417-426, Springer-Verlag. 1986.
[Moeller01] B. Moller, “Securing elliptic curve point multiplication against side-channel attacks.” Information Security—ISC 2001, LNCS 2200, pp. 324-334, Springer, 2001.
[Montgomery97] P. Montgomery, “Speeding the Pollard and Elliptic Curve methods of Factorization.” Mathematics of Computation, {\bfseries 48}(177), pp. 243-264, 1987.
[Quisquater01] J-J. Quisquater, and D. Samyde, Electromagnetic analysis (EMA): Measures and Couter-measures for Smard Cards. Smart Card Programming and Security—E-SMART 2001, LNCS 2140, pp. 200-210, Springer, 2001.
[Smart01] N. P. Smart, “The Hessian Form of an Elliptic Curve.” Cryptographic Hardware and Embedded Systems—CHES 2001, LNCS 2162, pp. 118-125, Springer, 2001.
[Theriault05] N. Thériault, “SPA resistant left-to-right integer recoding.” Selected Areas in Cryptography—SAC 2005, LNCS 3897, pp. 345-358, Springer 2005.
[Washington08] L. C. Washington “Elliptic Curves Number Theory and Cryptography” second edition, Chapman \& Hall/CRC, 2008
[Yen00] S.-M Yen and M. Joye, “Checking Before Output May not be Enough Against Fault-based Cryptanalysis.” IEEE Trans. on Computers, series 49 (9), pp. 967-970, 2000.

1. Atomic blocks to protect cryptosystems against simple side-channel attacks (SSCA) and C-Safe fault attacks, CHARACTERIZED in that they comprise eliminating the use of dummy operations in the atomic blocks used in the scalar multiplication ([d]P), which are based on elliptic curves defined on fields of prime characteristic.

2. The atomic blocks according to claim 1, CHARACTERIZED in that special algebraic substitutions are used for writing formulae of: General Addition, Modified Jacobian doubling and Mixted Jacobian and Chudnovsky Jacobian Addition, having an efficient structure of atomic block (S, N, A, A, M, A) when the scalar multiplication ([d]P) is implemented with right-to-left algorithms.

3. The atomic blocks according to claim 1, CHARACTERIZED in that they comprise balancing the number of squarings (S) and multiplications (M) by using the method presented in [Longa08] and [Bernstein07], as well as other algebraic substitutions to eliminate the use of “dummy” operations which may be subject to C-fault attacks.

4. The atomic blocks according to claim 3, CHARACTERIZED in that they comprise creating ordered pairs (Sᵢ,Mᵢ, wherein Sᵢ is a squaring followed by a multiplication Mᵢ per each atomic block.

5. The atomic blocks according to claim 1, CHARACTERIZED in that they comprise enumerating the minimum quantity of additions and negations required in each formula and determining each position thereof based on a data dependency graph.

6. The atomic blocks according to claim 2, CHARACTERIZED in that the first and last atomic blocks have less flexibility in the formula.

7. The atomic blocks according to claim 2, CHARACTERIZED in that they comprise determining the most compact and efficient structure of the atomic blocks.

8. The atomic blocks according to claim 7, CHARACTERIZED in that the most compact and efficient structure is the atomic structure (S, N, A, A, M, A).

9. The atomic blocks according to claim 2, CHARACTERIZED in that they comprise using the Right-to-left algorithm in the scalar multiplication ([d]P), writing formulae and atomic blocks for the case of Modified Jacobian doubling (2P), performing the operations between each atomic block and their respective registers R, (using 8 registers) and filling the “dummy operations” by means of general algebraic substitution 3a=2a+a.

10. The atomic blocks according to claim 2, CHARACTERIZED in that in the General Addition, (P+Q) using 11 registers wherein the algebraic substitutions applied to eliminate the use of dummy operations are 2b³=(b²+b)²−(b⁴+b²); and also comprising the calculation of an expression of the type c=2a+b as c=(a+b)+a, and 4AE²−X₃=[(2E)²−(2E²)(2E)−12(AE²)].

11. The atomic blocks according to claim 2, CHARACTERIZED in that for the case of Mixted Jacobian and Chudnovsky-Jacobian Coordinates Addition (P+Q) using 12 registers are used wherein their algebraic substitutions to eliminate the dummy operations are:
4H³=2(H²+H)²−2(H²)−2(H²)²,
−4U₁H²=[(H²)²−(2U₁+H²)²]+(2U₁)²,
G−2V=G+2[(H²)²−(2U₁+H²)²]2(2U₁)².

12. Method to protect cryptosystems against simple side-channel attacks (SSCA) and C-Safe fault attacks, CHARACTERIZED in that use the atomic blocks of the claims 1.
